(19) United States
(12) Patent Application Publication
(10) Pub. No.: US 2026/0253233 A1
(43) Pub. Date: Aug. 27, 2026

(54) DEVICES, SYSTEMS, AND METHODS FOR AUTOMATIC OBJECT DETECTION, IDENTIFICATION, AND TRACKING

(71) Applicant: Image Insight Inc., East Hartford, CT (US)

(72) Inventors: Eric P. RUBENSTEIN, Ellington, CT (US); Gordon A. DRUKIER, New Haven, CT (US)

(21) Appl. No.: 18/877,422

(22) PCT Filed: Jun. 21, 2023
(86) PCT No.: PCT/US23/68843

§ 371 Date: Dec. 20, 2024

Related U.S. Application Data
(60) Provisional application No. 63/354,400, filed on Jun. 22, 2022.

(51) Int. Cl. G06T 7/20; G06V 10/764; G06V 20/52

(52) U.S. Cl. CPC G06T 7/20; G06V 10/764; G06V 20/52; G06T 2207/30241; G06V 2201/07

(57) ABSTRACT

Disclosed embodiments may include a method for automatic object detection, identification, and tracking. This may include receiving video data from one or more sensors, processing the video data to detect one or more objects using a first group of one or more machine learning models, tracking characteristics of the one or more objects over time, classifying, using a second group of one or more machine learning models, each of the one or more objects based on the tracked characteristics, comparing each of the classifications to a database of known objects, predicting an estimated identity of each of the one or more objects based on the comparison, and predicting a future path of motion for each of the one or more objects based on the estimated identity and the tracked characteristics.

### CROSS-REFERENCE TO RELATED APPLICATIONS

This application claims priority, under 35 U.S.C. § 120, to U.S. Provisional Patent Application No. 63/354,400, filed Jun. 22, 2022, the entire contents of which are fully incorporated herein by reference.

### STATEMENT REGARDING FEDERALLY SPONSORED RESEARCH

This invention was made with government support under contract numbers FA864921P0540 and FA864922P0580 with the Air Force Research Laboratory awarded by the Department of Defense. The government has certain rights in this invention.

### FIELD OF THE INVENTION

The disclosed technology relates to devices, systems, and methods for automatic object detection, classification, identification, and tracking. Specifically, this disclosed technology relates to automatic object detection systems configured to process video data captured using digital cameras in daylight, dark, or low-light conditions.

### BACKGROUND

Drones, or unmanned aircraft systems (UAS), and other small objects can be significant threats to military base defenses and other land-based targets. Adversary nations and terrorists use commercial UAS for lethal attacks, for intelligence collection, and to achieve other effects. UASs are extremely low cost, deploy quickly, and are used in increasingly large numbers. Adversaries use them to challenge forces in numerous places and they can even be used to conduct swarm attacks. Furthermore, the detection of commercial UAS at night is difficult due to their low altitude and small size, and the rarity of thermal-infrared detectors. Consequently, an attack at night by a $200 UAS with a small explosive is likely to succeed. Additionally, military base defense systems may be able to detect larger objects, but only using dedicated, specialized, and expensive equipment. Furthermore, more conventional locations, such as sports arenas, may not have the budget to have specialized drone identification equipment.

Accordingly, there is a need for improved systems and methods for automatic object detection, identification, and tracking. Embodiments of the present disclosure are directed to this and other considerations.

### SUMMARY

Disclosed embodiments may include a system for automatic object detection, identification, and tracking. The system may include one or more processors, and memory in communication with the one or more processors and storing instructions that, when executed by the one or more processors, are configured to cause the system to provide for automatic object detection, identification, and tracking. The system may receive video data from one or more cameras. The system may also process the video data using one or more machine learning models of a first group of machine learning models to detect one or more objects, wherein each machine learning model of the first group of machine learning models is trained to detect different morphological classes of objects. In response to detecting a first object of the one or more objects by a first machine learning model of the first group of machine learning models, the system may continuously monitor the first object using the first machine learning model. Additionally, the system may track characteristics of the one or more objects over time. Furthermore, the system may calculate derived characteristics from the tracked characteristics. The system may classify, using one or more machine learning models of a second group of machine learning models, each of the one or more objects based on the tracked characteristics and the derived characteristics. The system may also compare each of the classifications to a database of known objects. Also, the system may predict an estimated identity of each of the one or more objects based on the comparison. Finally, the system may predict a future path of motion for each of the one or more objects based on the estimated identity, the derived characteristics, and the tracked characteristics.

Disclosed embodiments may include a system for automatic object detection, identification, and tracking. The system may include one or more processors, and memory in communication with the one or more processors and storing instructions that, when executed by the one or more processors, are configured to cause the system to provide for automatic object detection, identification, and tracking. The system may receive video data from one or more cameras. The system may also process one or more first frames of the video data using one or more machine learning models of a first group of machine learning models to detect one or more objects, wherein each machine learning model of the first group of machine learning models is trained to detect different types of objects. In response to detecting a first object of the one or more objects using a first machine learning model of the first group of machine learning models, the system may process one or more second frames of the video data using the first machine learning model to track characteristics of the first object over time. Finally, the system may calculate derived characteristics from the tracked characteristics.

Disclosed embodiments may include a system for automatic object detection, identification, and tracking. The system may include one or more processors, and memory in communication with the one or more processors and storing instructions that, when executed by the one or more processors, are configured to cause the system to provide for automatic object detection, identification, and tracking. The system may receive video data from one or more sensors. The system may also process the video data to detect one or more objects using a first group of one or more machine learning models. The system may furthermore track characteristics of the one or more objects over time. The system may classify, using a second group of one or more machine learning models, each of the one or more objects based on the tracked characteristics. Additionally, the system may compare each of the classifications to a database of known objects. The system may also predict an estimated identity of each of the one or more objects based on the comparison. Finally, the system may predict a future path of motion for each of the one or more objects based on the estimated identity and the tracked characteristics.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for automatic object detection, identification, and tracking in accordance with certain embodiments of the disclosed technology.

FIG. 2 is a flow diagram illustrating an exemplary method for automatic object detection, identification, and tracking in accordance with certain embodiments of the disclosed technology.

FIG. 3 is a block diagram of an example image analysis system used to provide automatic object detection, identification, and tracking, according to an example implementation of the disclosed technology.

FIG. 4 is a block diagram of an example system that may be used to provide automatic object detection, identification, and tracking, according to an example implementation of the disclosed technology.

FIG. 5 is an illustration of an example graphical user interface that may be used to interact with and operate the alert system.

### DETAILED DESCRIPTION

The disclosed system uses commercial off-the-shelf (COTS) cameras attached to small, low-cost computers to detect the LiDAR emissions used by many UAS as anti-collision, mapping, and altimeter sensors. Exemplary systems may integrate software with perimeter CCTV and other security cameras to provide 360-degree surveillance. Since security cameras are used on all military bases, installations may leverage existing infrastructure to achieve new situational awareness. Other, possibly internet-connected cameras (such as those in cellular phones) can provide remote detection capabilities to support related missions. These enhancements also enable detection of other near-IR emitters such as laser target designators, rangefinders, and mapping LIDAR. This detection capability may ultimately be integrated with defense systems to increase the speed of defeating threats. The system may also identify and track moving objects such as artillery shells, rockets, and aircraft, as well as to detect and alert on muzzle flashes at night. Resulting systems may feature a seamless integration of detections and tracking solutions of UAS and other threats with sufficient telemetry and confidence-level data and metadata to expand the operational performance of the base defense systems. This also allows for the use of the system in places that previously would not be able to be protected from such threats.

The system may include a series of image analysis, image processing, machine learning, time-series analysis, physics fitting routines, Kalman filter, cross-correlation, Fourier-transform, and related image and time-series numerical calculations operate on video taken under dark or nighttime conditions using digital cameras in order to automatically detect, classify, track, and extrapolate the positions of optical and/or near-infrared emitting objects, or to detect and classify explosions. These numerical and analytical processes may not necessarily operate in a linear sequence. Rather, various feedback mechanisms within the software allow for dynamic, data-driven decision-making to optimize the detection, tracking, classifying, and predictive capability, while seeking to minimize false-positive alarms. Included among these processes are Monte Carlo and other object recovery methodologies, including those described in U.S. Pat. No. 7,940,959 issued May 10, 2011, U.S. Pat. No. 8,155,382 issued Apr. 10, 2012, U.S. Pat. No. 8,452,049 issued May 28, 2013, U.S. Pat. No. 8,774,529 issued Jul. 8, 2014, and U.S. Pat. No. 9,014,488 issued Apr. 21, 2015, which are incorporated by reference herein in their entirety. Branch points occur either within the nested state machines that assess the progress, efficacy, and success of the analysis, or within executive routines outside those state machines.

Real-time or post-capture video analysis software may enable CCTV security cameras and cell phones to detect UAS, range finders, satellites, unmanned/uncrewed ground vehicles (UGV), and other optical and near IR-emitters. The system may run on local computers or in secured cloud enclaves. The detection software may pass open standard messages to warn individuals about potential attacks. Tactical users may utilize the system to detect and track small UAS in low-light and night-time settings. Operational, headquarter, and intelligence users may observe patterns of UAS usage, characterize UAS for attack attribution, and identify pre-attack recognition. Some high-level exemplary uses, advantages, and military applications of the disclosed systems may include: enhanced situational awareness against UAS and SUAS, prevents unnoticed UAS intrusion or attack, and adds night detection to unmodified security cameras. Furthermore, the system may autonomously detect adversary LiDAR for intelligence mapping, targeting lasers and rangefinders, unmanned ground vehicles (including auto-drive cars), which could conduct unmanned VBIED attacks, artillery, rockets, and tracer fire and muzzle flashes. Some additional advantages of the described system are that it is: extremely low cost, can be easily deployed to all cameras on all bases easily, and allows for a tactical advantage countering adversary use of COTS UAS and swarms of UAS. An example system may be summarized in the table below:

TABLE 1
Example System

| | |
|---|---|
| Sensor | uses digital cameras as sensor, leveraging unmodified |
| | mobile devices and security cameras |
| Filter | may optionally use a low-pass, high-pass, or band-pass |
| | filter to only allow a portion of the light spectrum to |
| | pass through (e.g., pass near infrared only wavelengths |
| | longer than 760 nm, or pass near ultraviolet only |
| | wavelengths shorter than 350 nm) |
| Software | runs on laptop/desktop, cloud-based servers, on-premise |
| | servers, and mobile devices |
| Measure | optical and near-infrared emitters in dark, low-light, |
| | and daylight |
| Detect | aircraft, UAS, unmanned ground vehicle (UGV), rockets, |
| | artillery, muzzle flashes, target designators, mapping |
| | LiDAR, etc. |
| Localize | determine location, area of impact, and area of origin |
| Track | determine trajectory of moving light-emitters |
| Classify | assess category of object (e.g., stationary building |
| | light, ballistic weapon, rocket, powered flight, |
| | satellite, etc.) |
| Environment | night, low-light, or daylight |
| Modes | real-time or forensic |
| Operational | Daytime and nighttime awareness of optical and near- |
| Impact | infrared emitting or reflecting objects |

The systems and methods described herein utilize, in some instances, graphical user interfaces, which are necessarily rooted in computers and technology. Graphical user interfaces are a computer technology that allows for user interaction with computers through touch, pointing devices, or other means. This, in some examples, may involve detecting objects and displaying the motion and projected motion of objects in real time on a dynamically changing graphical user interface so that a user can see otherwise imperceptible objects displayed on a live video feed. Using a graphical user interface in this way may allow the system to provide real-time alerts and warnings to the user.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

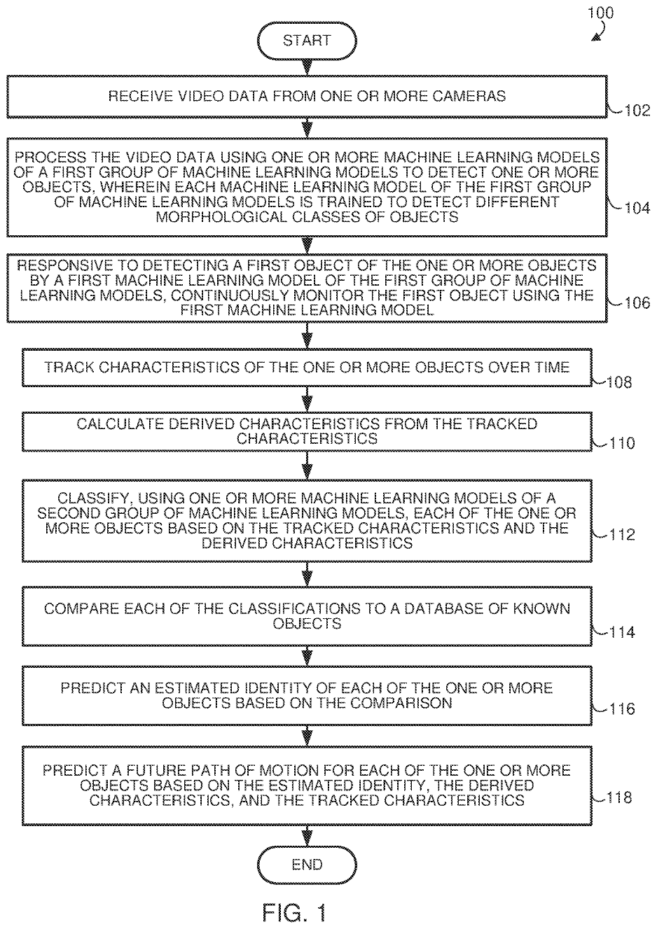

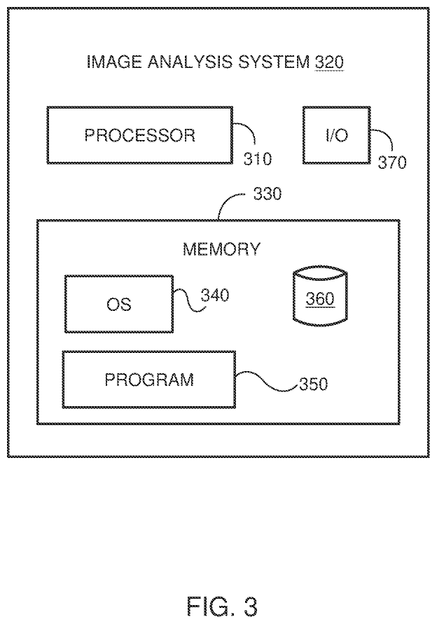

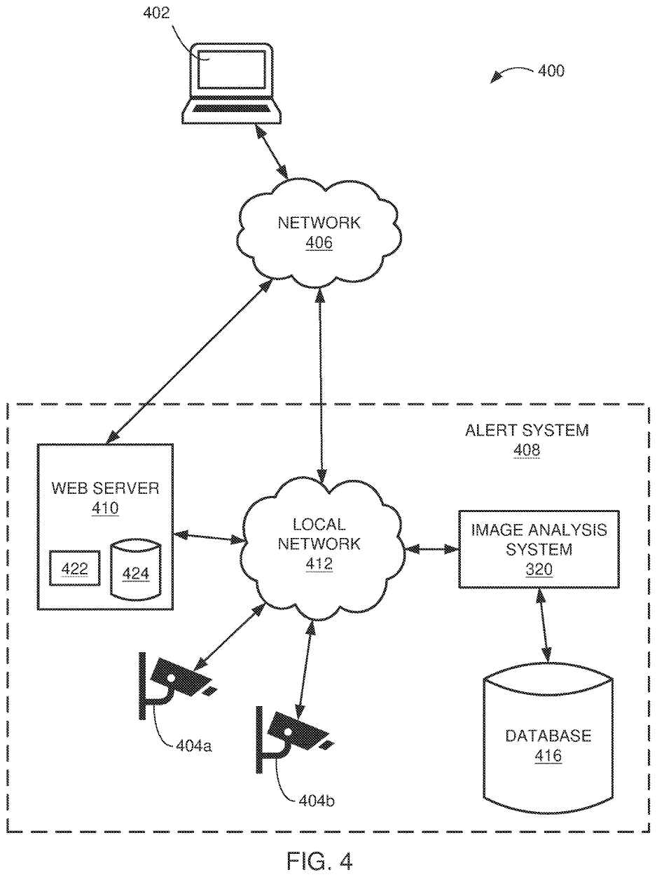

FIG. 1 is a flow diagram illustrating an exemplary method 100 for automatic object detection, identification, and tracking, in accordance with certain embodiments of the disclosed technology. The steps of method 100 may be performed by one or more components of the system 400 (e.g., image analysis system 320, or a server of alert system 408, or user device 402), as described in more detail with respect to FIGS. 3 and 4. Furthermore, one or more of the steps of method 100 may be optional.

In block 102, the image analysis system 320 may receive data from one or more cameras. The data may include video data or image data over a variety of successive frames. In various embodiments, elements of the disclosed systems may include, use, or incorporate the following data sources and environments: cameras or other image capture devices configured to capture images of salient visual environments (daytime sky, nighttime sky, twilight sky, or ground scenes that are unevenly illuminated with some areas containing insufficient light, or having insufficient angular resolution, to be able to detect or measure the morphology of objects via visual inspection). Such environments might include objects that are too poorly illuminated for the shape of objects to be seen in captured videos. Another non-limiting example of such a scene includes objects that are so small, or so far away, that the captured video provides too little morphological information for one skilled in either traditional image classification or machine learning classification techniques to be able to determine the type of object.

The data may include image data of one or more visual or optical near-infrared (ONIR) emitting or reflecting objects (generically referred to as “emitters” or “emitting objects”), for example: aircraft, lightbulbs, rockets, tracer bullets, laser target designators, vehicles, LiDAR emitters, spacecraft, satellites, ships, flashlights, and video collected from these environments, and other optical and near-infrared (NIR) emitting objects (transient and sustained emission of optical and/or NIR).

In some embodiments, the camera may include a filter. In such an embodiment, the light may pass through the filter before being recorded by the camera. Such filters may be used to restrict the light to portions of the light spectrum. Non-limiting examples of such filters include those that: allow light with wavelengths longer than 760 nm, exclude light with wavelengths longer than 360 nm, or only allow light with wavelengths between 500 nm and 600 nm. Other filter combinations may be used for specific purposes, for example to exclude contamination from high-pressure sodium lamps. In some embodiments, filters generally useful to night photography and astrophotography may also be useful to augmenting the present system.

In some embodiments, the video data may be optionally pre-assessed for its optical characteristics (e.g., brightness, contrast, color, color distribution), morphological properties (e.g., scene complexity, number and type of discrete objects within scene), and degree of temporal variability of both its optical characteristics and morphological properties.

In some embodiments, image analysis system 320 may receive additional inputs. To improve the system's ability to differentiate between movement along the ground plane and in the air or space above it, additional inputs may be useful, such as elevation (above sea level) and direction (in degrees) of the camera, elevation models of the visible terrain (provided from global positioning satellite (GPS)), and/or video from the camera during the day. It may useful for image analysis system 320 to map areas within the field of view that intersect the ground. Objects detected on those areas may be relatively more likely to be ground objects if their movement is consistent with displacement along Earth's surface. In one example, since the system may be designed to work in the dark, a low-flying UAS may be visually coincident with the ground, but if the motion is more consistent with a drone than a car, the resulting kinematic mismatch may be a useful indicator to image analysis system 320 in determining the nature of the object.

In some embodiments, the video data may be is optionally pre-processed by one or more of the following steps completed by image analysis system 320: histogram normalization of counts throughout the image, deskewing of flux across image, subtraction and/or multiplication of an episodically-calculated median image extracted from the video sequence, subtraction and/or multiplication of the prior frame, subtraction and/or multiplication of an image constructed by median-filtering together the prior/current/next frame of a video sequence, subtraction and/or multiplication of other reference images whose variations of construction are understood by those skilled in the art to include variations of numbers of frames and proximity to the current-to-be-analyzed frame.

In block 104, the image analysis system 320 may process the video data to detect one or more objects. The image analysis system 320 may use one or more machine learning models of a first group of machine learning models to detect the one or more objects. Each machine learning model of the first group of machine learning models may be trained to detect different objects or different types of objects. The machine learning models may be trained to detect different morphological classes of objects. Alternatively, the video data may be is optionally processed by one or more machine learning models sequentially in order to detect an ONIR-emitting object. The machine learning models may be configured to output a binary value indicating whether an object has been detected or a confidence value (e.g., a percentage value indicating the chance of the detection being a particular type of object). The machine learning models may be configured to output an indication or the coordinates of the detection of an object, which may be shown through bounding boxes or through other means. The machine learning models may be coordinated to operate with a certain type of image pre-processing. The machine learning models may process each frame of image data from the video data separately or may process multiple frames of video data at one time. The machine learning models may iteratively review image data frame-by-frame as video data is received. Once one or more of the machine learning models identifies an object, the machine learning model may be able to monitor or track the object over multiple frames. The image analysis system 320 may then be able to compare the track of the object identified by the machine learning model over multiple frames (as described more specifically in block 108).

In some embodiments, the machine learning models may detect objects, types of objects, and classify types of objects. In other embodiments, the machine learning model detection and classification scheme may include various morphologies of light sources, not just classifications of objects or types of objects. The scheme may be include determining what the light source looks like. The morphological classification may determine what types of photometry, surface brightness mensuration, and colorimetry may be performed on that particular detected object. Thus, the classification derived from the machine learning model may drive subsequent analysis. In turn, after the photometry, surface brightness mensuration, and colorimetry is performed, an object type classification may be made and further machine learning systems may be utilized to draw further inferences (as described in block 112). Exemplary morphological classes may include:
a. Unresolved source—These are small sources of order a few pixels across and axisymmetric to the extent that they can be determined from objects that are just a few pixels across. Examples include distant lights, satellites, and slow-moving objects. In depth optical characterization on these objects may be limited to flux and color measurements and measures of symmetry related to its profile compared to a measured point spread function.
b. Linearly extended source—These objects may be resolved in one dimension, but not the other. Examples include fast-moving objects, tracer bullets, distant artillery shells in flight, or tightly packed lights. The long dimension may be indicative of motion direction or a potentially extremely high aspect ratio. Measurement may provide total measured light flux, color, location of object's centroid, object's length, and orientation.
c. Extended symmetric source—These objects may be resolved in all dimensions, may be axisymmetric or elliptical, and their brightness distribution may be measured (e.g., to determine if it is generally brighter in the middle than the extended region, or uniformly illuminated, or has some other light distribution). Examples include headlights and other lamps, especially if viewed through fog. Photometry, surface brightness mensuration, and colorimetry may measure total flux of light, centroid, size, radial profile, deviations from axisymmetry, overall morphology, and color distribution.
d. Smooth irregular objects—These objects may include extended irregularly shaped sources with roughly uniform light levels. Examples include distant cities, sky glow, illuminated clouds. Photometry, surface brightness mensuration, and colorimetry may measure an object's total light flux, centroid, size, shape, surface brightness, surface brightness variations, color, and color distribution.
e. Irregular objects—These objects may be extended, irregular, multi-modal sources. Examples include lights viewed through smoke or other patchy obstruction or diffusion, vehicles at a distance where their running lights are barely resolved. This may be a large and varied class. Photometry, surface brightness mensuration, and colorimetry may measure an object's total light flux, size, surface brightness, surface brightness variations, shape, color, and color variations, but may also include an attempt to break the irregular object into smaller components.

Some machine learning models may require specific training. For each class that requires a training data set, the size, composition, and variations may be substantial (e.g., thousands of individual images, with more required for the most complex classifications). This training data most be comprised of a representatively wide range of examples of each type of classifier. It may be expected that some of the videos may supply data for multiple classifications. Videos may be selected to have as little camera motion as possible, unless there is no background. One or more machine learning models may be based on the YOLO machine learning model, other machine learning and machine vision models, or may be constructed specifically for use with image analysis system 320.

In some embodiments, the machine learning models may be trained to process both preprocessed and non-preprocessed images. While images may be pre-processed to enhance the visibility of the sources, there may be circumstances where this may be difficult, such as during a storm (or other times when camera visibility may be obscured). Consequently, object classification may have to be performed both with and without preprocessing. The same training frames may be used for preprocessed and non-preprocessed data sets, and the bounding boxes and labels may be suitably transferred but modified to reflect the differences. Machine learning models may be coordinated to preprocessing options. Examples of preprocessing options for the machine learning models may include categories of: (1) none; (2) subtraction of a median made from many preceding frames; (3) subtraction of a median consisting of this frame and adjacent frames; (4) subtraction of a smoothed version of this frame; and (5) others described above.

Several different machine learning approaches may be used. For example: (1) the system may use one model with all the classifications; (2) the system may use separate machine learning models coordinated for each set of pre-processing types and/or source classifications, with the frame being passed to one appropriate model; or (3) the system may operate as with previous approach but using all machine learning models for processing and then using thresholds to pick the best outcomes from the various models. To minimize the computational expense and complexity, a library of previously calculated examples can be referenced to look-up which models were most appropriate for past, similar examples (e.g., see related description with reference to block 106).

The machine learning models may use a variety of feedback loop mechanisms for additional training and refinement. This may result from feedback from image analysis system 320 picking one model over another and using a first model to train a second model. This may also result from processing multiple frames of the video feed using earlier and/or later frames from the video of an identified object to further train the machine learning models. This may also result from image analysis system 320 making a later classification of an object in block 112 or identification of an object in block 116 after processing the video data, and then using frames from the video data to train one or more of the machine learning models of an appropriate morphological classification based on the identification.

In block 106, the image analysis system 320 may, in some embodiments, be responsive to detecting an object of the one or more objects by a first machine learning model of the first group of machine learning models, and then continuously monitor the object using the first machine learning model. In some embodiments, the system may use multiple machine learning models to process individual image frames of the video data. The multiple machine learning models may be sequential (where each machine learning model processes the data after another to determine a single final result) or in parallel (where each machine learning model processes the data individually and each machine learning model comes up with a final result). When the machine learning models are used in parallel, a single machine learning model of the group may produce a result for identifying an object that is not identified by the other machine learning models of the group. In this case, the machine learning model that identifies the object that is not identified by the other machine learning models may be preferentially used to process additional image frames of the video data (thereby tracking the object). The preferential status of a certain machine learning model may be established by using a threshold or comparison to other machine learning models of the group. Once a machine learning model is given a preferential status, the other machine learning models of the group may be used to process the video data at a less frequent rate (e.g., every 10 number of frames), which may be used to save computing resources. If one of the other machine learning models then detects a different object, the other machine learning model may be given preferential status along with the first machine model monitoring the first object.

In block 108, the image analysis system 320 may track the characteristics of the one or more objects over time. Tracked characteristics may include position, distance, velocity, brightness, color, shape, or other information. Tracking may be completed along multiple image frames. The system may record the data as determined by the one or more machine learning models in the first group of machine learning models. A time-series accumulator may track the historical, current, and potential future positions of the detected ONIR-emitting object(s). Each such track may be fit to make predictions of future movement (e.g., this process may be made in conjunction with block 118). Discrepancies between an updated position and the prediction are used to update the trajectory calculator and may also be used to build goodness-of-fit statistics to assess the system's current state. These discrepancies may be used as a measure of empirical error in subsequent kinematic calculations.

The image analysis system 320 may measure and track various details of objects detected by the artificial intelligence and machine learning detection system for each camera. These measurements include: (1) the position of the object based on the center of the bounding box; (2) the centroid of the light distribution (which may be a gaussian, a Moffat function, a Lorentzian, a pseudo-Lorentzian, or other typical optical light distribution models); (3) the object brightness in terms of the total amount of light above the background level; (4) the object brightness in terms of the differential amount of light compared to a specific object (e.g., a specific star, a specific set of stars, other objects known to have either a known brightness or varying on timescales much longer than the observations); (5) the object brightness in terms of the differential amount of light compared to a specific extremely well-characterized “standard” objects (e.g., a specific star, a specific set of stars, or other objects known to have extremely well characterized brightness consistent with use as a brightness standard); (5) the color of the object by comparing the brightness measured in each of the RGB bands, or in terms of other standard color spaces such as HSV or Y′CbCr; and/or (6) the size, shape, and orientation in terms of image moments, fitted ellipsoids, or the like.

In cases where multiple detections are connected together by a solid body model of a single object, the orientation and relative distances between the components may be measured based on the locations, sizes, and/or orientation of each of the components. Where possible for such connected solid body model, the position of the object may be referenced to the presumed center of light, center of mass, or other such inferred typical position for the object.

In some embodiments, comparison of photometry of an object tracked across different image frames enable the calculation of changes in brightness and color.

In some embodiments, the system may search for visual “collisions” (e.g., instances where tracked objects become too close together in the video to be separately identifiable or where noise, error, or confusion may lead to such indeterminate outcomes. An optional assessment package evaluates each ONIR-emitting object that entered the visual area of such a “collision”, the intended function of which may be to assign one or more figures of merit to each input-output mapping based on: (1) the implied change in velocity, acceleration, and/or energy required to affect such a mapping. The mapping that requires the smallest variation from what was predicted for the system prior to the “collision” may be taken to have the highest figure of merit. (2) The use of photometrically-derived information (e.g., color of ONIR-emitting object, brightness, morphological information) may provide additional figures of merit. (3) These figures of merit may be evaluated to determine the best, presumptive input-to-output mapping. Each input-to-output mapping that is found to be feasible, and their figures of merit, may be optionally maintained for future reference and to maintain probability of correct determination.

In block 110, the image analysis system 320 may calculate or determine derived characteristics from the tracked characteristics. Derived characteristics may include characteristics that can be determined from using two or more cameras or detectors. Derived characteristics may be calculated from tracked characteristics. This may comprise physical size, distance from each of the cameras, velocity, acceleration, rotation, or other features. As emitters are tracked, an assessment may made of whether they are moving or not. While many non-moving ONIR-emitting objects may be excised from subsequent analysis during preprocessing, some may remain depending on the type of preprocessing in use or photometric variability. Consequently, it may be important to differentiate among stationary, moving, and previously-moving emitters. One non-limiting set of categories used to flag detected object follows. Derived characteristics may include emitter movement indicators or flags, including: (1) new: object just detected; (2) always stationary: object has not moved more than some threshold amount; (3) new-mover: object has just begun to move (either due to first movement ever recorded, or first movement in a time long enough to exceed system record-keeping policies); (4) mover: object has been moving and still is; (5) prior-mover: object has been moving recently, but is now motionless or its motion is less than a configurable threshold. “Recently” may also be a configurable quantity selected to be useful for a given context (e.g., 30 seconds for an aircraft, 15 minutes for a ground or sea vessel); and (6) currently-stopped: object has not moved recently, but at some time in the past was a “mover.” “Recently” may also be a configurable quantity selected to be useful for a given context (e.g., 30 seconds for an aircraft, 15 minutes for a ground or sea vessel).

In some embodiments, comparisons between frames of objects connected by the tracking system may be used by the system to measure the angular velocity by comparing the position from frame to frame and combining this with the known plate scale of the system. Similarly, radial motion may be measured by image analysis system 320 by comparing the size of a single detection, when it is resolved, or changes in the distances between constituent lights where these exist. As they increase/decrease the object may be moving towards/away from the field of view, and given the plate scale, the angular change may be measured by the system. If the distance is known, then absolute angular and radial velocities may be calculated by the system as well. Alternatively, if the size of the object being studied is known, these measured angular separations can be used to compute the absolute distance to the object. If all motions are known in physical units, then a full 6-dimensional state vector may be known and stronger limits may be placed on the knowledge and prediction of future physical motion. The radial and angular components may differ when seen by cameras with different viewpoints, which may reduce uncertainties and allow for a better estimate of the three-dimensional motion. As additional cameras and vantage points/perspectives accumulate, better estimates may be made. Image analysis system 320 may integrate the information provided from multiple camera feeds over time.

For each object, image analysis system 320 may derive a 6-dimensional state vector consisting of its 3-dimensional position relative to some reference, and its 3-dimensional velocity in an appropriate reference frame, as a function of time. The position may be measured by combining the positions as seen from each of two or more cameras. This may require that the position and viewing angle of each camera is known and input to image analysis system 320, and that the region of overlap of the fields of view is also known or determined. Objects that appear in multiple cameras with overlapping fields of view are candidates to be the same object and then able to be fused by the system into one object for tracking purposes. The image analysis system 320 may also use information from multiple video frames in this context.

The location of an object in the field of view of a camera may be used by image analysis system 320 to define a vector pointing in the direction of the object for each frame. This may be calculated by image analysis system 320 by considering where the position of the object projects to in the view frame. Where there is some uncertainty in the position of the object in the frame, then the uncertainty around the vector may define a cone where the object may be likely to be. When the object is visible in the view of multiple cameras located at different positions, or with different viewing angles, the overlap of the detection vectors or cones may give image system 320 a refined 3D location of the detected object. Measurement of parallax between nearby cameras is one example of this type of measurement. This comparison may then give the distance of the object relative to each of the cameras. Where there are more than two cameras, the combination of all location vectors or cones may further refine the position estimate. Where the vectors or cones do not overlap or intersect, then the image analysis system 320 may infer that multiple objects are being detected and refine its tracking model appropriately.

Where there are multiple objects being tracked, if the observed positions in one camera's view intersect as determined by image analysis system 320, the predicted trajectories may be used to disentangle the objects once they separate. Where they are detected on multiple cameras, then the objects may be distinguished by considering their positions as derived from the multiple perspectives. Synchronization of the video and subsequent measurements from the multiple cameras may be required to ensure that the association of the measurements of objects may be done in a consistent manner. Any uncertainties in the synchronization may lead to uncertainties in the inferred position and velocity of objects seen in the multiple cameras.

When multiple objects are seen in the field of view, the image analysis system 320 may assess the extent to which they share a common motion. When these are visible in two or more camera views, then image analysis may compare the state vectors of the objects. In the absence of multiple viewing angles, the motion of the objects may be compared. The image analysis system 320 may assess the likelihood that the multiple objects represent a single object moving as a solid body. Each detection may then be considered as a component of the solid body. As the detections move, the solid body may be rotating about multiple axes with respect to the fields of view, so the motion of the components may represent a combination of the motion of the center of mass of the solid body, and rotation about the center of inertia, which may be different. The image analysis system 320 may predict the motion of the solid body but may also contain additional components, such as predicting the motion of the components as the object rotates. Where the physical model is appropriate to a drone with multiple fans, for example, or a winged platform, image analysis system 320 may determine the relative motions of the components to be consistent with the physical motion. So, for example, if the motion of the object is modeled as powered flight in a particular direction, and the nature of the object is such that motion at that velocity and direction requires that the object tilt at a particular angle and direction, then the motion of the components should be determined by image analysis system 320 to match that prediction.

The system may operate with continuous feedback as the predictions of the models are compared with object motion. Deviations from predictions may be used to refine the modeled motion. One or more tracking models may be used to track objects using the tracking characteristics or the derived characteristics.

In block 112, the image analysis system 320 may classify each of the one or more objects based on the tracked characteristics and/or the derived characteristics. Classifying the one or more objects may use a second group of one or more machine learning models. The objects may be assigned to a class. Example classes may include: (1) null: static, non-moving; (2) ballistic: object's movement is consistent with a ballistic flight path affected by gravity and air resistance; (3) ground plane: object's movement is consistent with displacement along Earth's surface (ground or water); (4) orbital: object's movement is consistent with displacement along an extra-atmospheric orbit, e.g., above Earth's atmosphere, or above the Moon (examples include low-earth orbit, geosynchronous, Molniva, cis-lunar, etc.); (5) powered flight; object's movement is inconsistent with displacement along Earth's surface or on orbit. Velocity vector changes, especially those with a significant vertical component discordant with the known surface of the Earth within the camera's field of view suggest powered flight; (6) indeterminate: insufficient information exists to make a trajectory assessment with a high degree of confidence.

In some embodiments, the machine learning models of the classifier may generate a classifier probability (e.g., the probability an object is within a certain class). In addition to that estimate, the photometric and kinematic properties extracted during later stages of analysis contribute to a more holistic assessment of existence and quantitative measurements of an object's consistency (e.g., the system may determine if the object's size, brightness, color, and kinematic properties are consistent with its assessed classifier). For example, the image analysis system 320 may determine if the observed change in kinematic behavior of an object currently classified as a low-Earth orbiting satellite invalidate its membership in the class. Stated differently, the image analysis system 320 may leverage measured data, metadata, calculated properties, and the physical laws of motion to determine the degree of consistency of a classification. To render these quantitative probabilities more quickly useful to human operators, categories may optionally be used in presenting results. One non-limiting example of converting quantitative results, possibly useful for machine-to-machine transfer of information (“API level integration”), into a qualitative system useful for human operators or supervisors may include the following categories:
Unlikely-Contact (e.g., probability of object belonging to classifier <30%).
Possible-Current-Contact (e.g., probability of object belonging to classifier <80% confidence).
Probable-Current-Contact (e.g., probability of object belonging to classifier >80% confidence).
Confirmed-Current-Contact (e.g., at least two orthogonal goodness-of-fit metrics have probability of object belonging to classifier >95% confidence).
Possible-Recent-Contact (e.g., probability of recently seen object belonging to classifier <80% confidence, but object currently undetected. In some embodiments, recently seen may be a configurable parameter, such as 30 seconds or 5 minutes).
Probable-Recent-Contact (e.g., probability of recently seen object belonging to classifier >80% confidence, but object currently undetected. In some embodiments, recently seen being a configurable parameter, such as 30 seconds or 5 minutes).
Confirmed-Recent-Contact (e.g., at least two orthogonal goodness-of-fit metrics have Probability of recently seen object belonging to classifier >95% confidence. In some embodiments, recently seen being a configurable parameter, such as 30 seconds or 5 minutes).

In block 114, the image analysis system 320 may compare each of the classifications to a database. The system may contain a database of known objects which are potentially visible to the system. These may include, for example, all known models of drones, aircraft, rockets, artillery shells, etc. Where available the database may include for each object, among other things, the object's dimensions, locations of optical lights, LiDAR emitters, intensity, colors or wavelengths of such emitters, frequencies for on-off cycles, color-changes, pulsations or other variability in the light; flight characteristics including minimal and maximal air speeds, accelerations, climb rates, and similar performance information, color of the object itself and any patterns, and a three dimensional (3D), computed aided design (CAD) model of the object.

In block 116, the image analysis system 320 may predict an estimated identity of each of the one or more objects based on the comparison. As part of its inference engine, the image analysis system 320 may compare the characteristics of the observed objects and the derived motion model against the contents of the database and look for the best matches. Data from the database for the preferred matches may then be used in refining the models. In cases where the database information causes the model fits to the data and physical constraints to become poorer (e.g., below a predefined minimum threshold), the image analysis system 320 may determine the weaker the likelihood of this object matching that database item. The database information may not be affected by this determination because of the weak correlation between the object and the estimated identity. Where the fit becomes better (e.g., exceeds the predefined minimum threshold), then the assessment may be that it is more likely that this is the detected object. The image analysis system 320 may detect the presence of or identify a new variant of a known object when the match is sufficiently similar (e.g., above a predefined threshold but non-identical). The system may include a variable number of estimated identities of the object, ranked by a percentage of confidence that the object is the estimated identity.

In block 118, the image analysis system 320 may predict a future path of motion for each of the one or more objects. This predicted future path of motion may be based on the tracked characteristics, the derived characteristics, and/or the estimated identity. The prediction of the future path of motion may utilize a third group of one or more machine learning models. This may be made in conjunction with one or more other blocks, such as block 110 or block 112.

As time passes and the objects move, entering and leaving the field of views of the various cameras, the image analysis system 320 may update its model of the number of objects, and their state vectors. Past motion of each modeled object is then used to predict the future position of the object by use of a Kalman filter or the like that extrapolates past motion together with potential uncertainty in the future position and velocity. Alternatively, the system can employ a physical model for motion that includes predictions based on the estimated identity for inertial and powered flight with different profiles, including ballistic motion with air resistance, winged gliding, powered winged flight, powered low-speed rotor flight or multi-rotor flight and the like. As additional data is gathered, the image analysis system 320 may compare the actual motion with predictions made by the various models or filters. The machine learning models or filters that are most successful in predicting the motion may be favored in future predictive steps.

In some embodiments one or more of the blocks of the above method may be optional (e.g., unused), combined with another block, or performed in a different order than described. For example, the image analysis system 320 may determine the future path of motion (as described with reference to block 118) immediately following block 108 (after determining the track of the object). Alternatively, the future path of motion could also be completed after determining derived characteristics about the object (such as movement indicators in block 110) or after classifying the object in block 112 (as having a type of trajectory). Furthermore, method 100 in its entirety or certain processes of method 100 may be performed iteratively (e.g., blocks 102, 104, 106). As the system receives video data and processes frames (either individually or more than one at a time), the system may constantly iterate and improve objects tracks and estimates regarding the object.

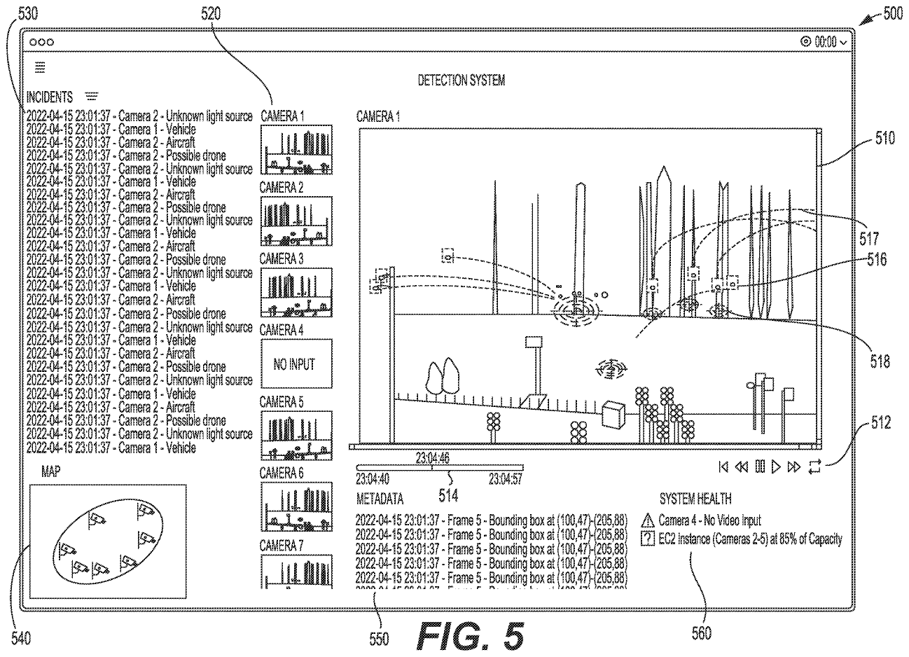

In some embodiments, as the image analysis system 320 retains more data regarding a tracked object (or alternatively, as soon as the system identifies a potential object), the image analysis system 320 may generate and transmit the data regarding the object in a graphical, interactive, real-time form, to a graphical user interface. This allows a user to be aware of the object in real-time via the graphical user interface, which the user may not otherwise be able to identify. Details of the graphical user interface are explained with reference to FIG. 5.

A non-limiting example may further be used to illustrate method 100. In this embodiment, two objects on ballistic, non-powered, aerial trajectories appear to occupy the same location in one 2-dimensional image, forming an apparent visual “collision” in one image. The input-to-output mapping that allows each object to continue its predetermined parabolic (or nearly parabolic) path is vastly more likely to be correct than the one that requires two projectiles to simultaneously sharply alter course. The process for evaluating this assessment may involve one or more of the following steps:
1. Detect each object of interest in a series of images drawn from video (block 102)
2. From image to image (e.g., frame to frame within the video), track location (e.g., spatial centroid location, locus of outer perimeter of object, center of brightness distribution), photometric properties (brightness, color), and morphological (e.g., shape, skew, kurtosis of light distribution, light distribution map of object, color distribution map of object) properties of each object (blocks 104 and 108)
3. Calculate preliminary trajectory for each object satisfying equations of motion and determine goodness of fit figure of merit. Note that the simultaneous use of two or more cameras each observing at least one of the objects may allow for an enhanced, 3-dimensional target solution to be calculated. Such stereoscopic observations enhance the precision and accuracy by both providing trigonometric solutions and enhancing the total collected signal from each object (block 110).
4. Loop through set of possible trajectories for ensemble of detected objects picking the input-to-output map that offers the best fit in terms of least action, conservation of energy, conservation of angular momentum, consistency with equations of motion relevant to the environment (e.g., within Earth's atmosphere, low Earth orbit, ships crossing on the ocean's surface, vehicle headlights eclipsing while driving across a dark field, etc.).
5. In parallel with steps 3 and 4, calculate the changes (derivative and higher order derivatives when numerically possible) of photometric properties (brightness, color), and morphological (e.g., shape, skew, kurtosis of light distribution, light distribution map of object, color distribution map of object) properties of each object. An objective is to seek an independent assessment of an object's consistency of properties.
6. The results derived from the kinematic assessments (step 3 and 4) and the photometric mensuration assessments (steps 2 and 5) are used to make a combined best estimate of the mapping of input objects to output objects following an optical collision (or eclipse).

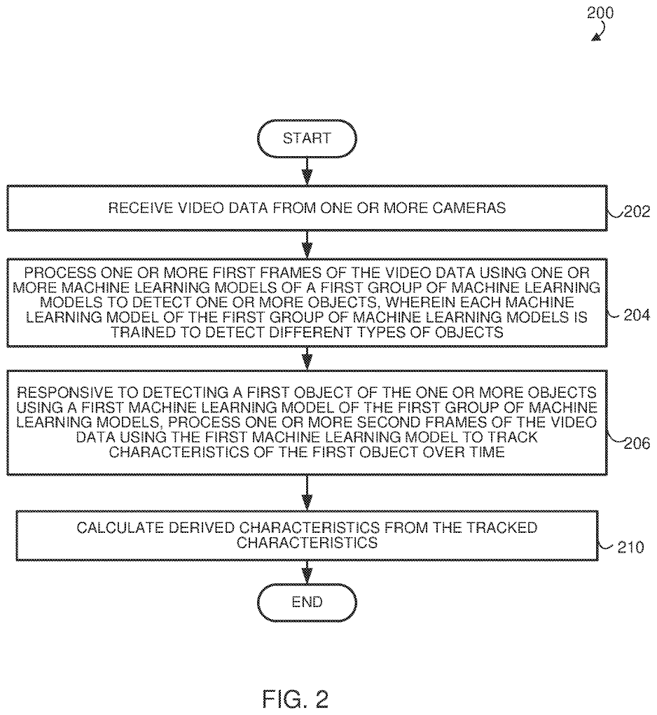

FIG. 2 is a flow diagram illustrating an exemplary method 200 for automatic object detection, identification, and tracking, in accordance with certain embodiments of the disclosed technology. The steps of method 200 may be performed by one or more components of the system 400 (e.g., image analysis system 320, a server of alert system 408, or user device 402), as described in more detail with respect to FIGS. 3 and 4.

Method 200 of FIG. 2 is similar to method 100 of FIG. 1, except that method 200 may not include blocks 108, 112, 114, 116, or 118 of method 100. The descriptions of blocks 202, 204, 206, and 210 of method 200 are similar to the respective descriptions of blocks 102, 104, 106, and 110 of method 100 and are not repeated herein for brevity.

Further uses of the example image analysis system 320 included stereoscopic triangulation. Observations from multiple, widely spaced cameras may be used to provide the additional information required for stereoscopic range determination of objects. In some embodiments, machine learning model detections of objects have sufficient information to be useful for additional or further cyber-physical measurements. Specifically, by determining rough locations of objects, the system may be used to alert base defense systems that may have targeting sensors. In other embodiments, the system may communicate sufficiently precise location information to defense systems and allow external systems to engage and neutralize threats while allowing the defense system to maintain electromagnetic emissions control (EMCON).

Additionally, image analysis system 320 may be used to detect objects in daylight or daytime conditions using filters. The system may operate in a similar manner for detecting objects in daylight as detecting objects at night or in low-light conditions. Long-pass filters (>760 nm) may be used to remove daylight as much as possible and to restrict light capture by the cameras to near IR (NIR). This may allow LaUDS to detect IR emission against a filtered daytime sky (e.g., UAS with a standard beacon or LiDAR emitting UGV). In daylight conditions, LaUDS may also detect the IR reflection from the sun on objects rather than IR emissions (e.g., multiple UAS at a wide range of Sun-UAS-Camera geometries or moving and stationary ground targets and objects).

While the filter generally may reduce sky brightness and increased contrast, the sun is a bright NIR emitter and vegetation is IR bright. Consequently, the filtering may not render the view into the equivalent of night or other low-light conditions. However, in order to combat this, the system may use additional training data to specifically train the machine learning models for filtered daylight detection. Furthermore, a different machine learning model could be used for daylight detection (e.g., one or more first sets of trained machine learning models used for nighttime detection and one or more second sets of trained machine learning models used for daytime detection). The image analysis system 320 may also use spatio-temporal filters and other types of optical or software analysis filters to reduce ground clutter during daylight monitoring and operation. The image analysis system 320 may employ different or enhanced image preprocessing to aid in twilight and daytime detection (e.g., using methods to increase contrast between the emitter and background and reduce obscuring complexity in the background). As with nighttime and low-light detection, the system may also be able to predict impact points and launch points using estimator algorithms.

Overall, the image analysis system 320 may employ different systems designed to work together in order to achieve round-the-clock monitoring in all light conditions (e.g., full daylight, twilight, and night). This approach may include switchable systems that work together. For example, the system may use cameras that have multiple sets of filters and/or dynamic filters that can be switched in or out of the optical path, or software modules than can be switched on or off, or otherwise modified depending on the ambient lighting conditions (e.g., high-pass filter during the day to block light, other filters or no filters at night). Other visible light filters or a broader array of lenses may allow for additional operational capabilities (e.g., a combination of a long pass filter and a short pass filter could allow for a more targeted approach). The system may include multiple types of machine learning models dedicated and trained for specific lighting conditions (e.g., for daylight, nightlight, or low-light). The system may actively switch between the different model options based on current assessments of light level, scene complexity, objects being tracked, or other calculated or measured quantities. Furthermore, the image analysis system 320 may include machine learning models specifically trained to detect different objects (e.g., UAS, surveillance balloon) or specifically to designate the target of the object. Each machine learning model may have variants to detect the different objects in a different condition. Machine learning models may be specialized to detect objects in different ways (e.g., via IR reflection from the sun or IR emission from the object).

FIG. 3 is a block diagram of an example image analysis system 320 used for automatic object detection, identification, and tracking according to an example implementation of the disclosed technology. According to some embodiments, the user device 402 and web server 410, as depicted in FIG. 4 and described below, may have a similar structure and components that are similar to those described with respect to image analysis system 320 shown in FIG. 3. As shown, the image analysis system 320 may include a processor 310, an input/output (I/O) device 370, a memory 330 containing an operating system (OS) 340 and a program 350. In certain example implementations, the image analysis system 320 may be a single server or may be configured as a distributed computer system including multiple servers or computers that interoperate to perform one or more of the processes and functionalities associated with the disclosed embodiments. In some embodiments image analysis system 320 may be one or more servers from a serverless or scaling server system. In some embodiments, the image analysis system 320 may further include a peripheral interface, a transceiver, a mobile network interface in communication with the processor 310, a bus configured to facilitate communication between the various components of the image analysis system 320, and a power source configured to power one or more components of the image analysis system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the image analysis system 320 may include one or more storage devices configured to store information used by the processor 310 (or other components) to perform certain functions related to the disclosed embodiments. In one example, the image analysis system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The image analysis system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the image analysis system 320 may include the memory 330 that may include one or more programs 350 to perform one or more functions of the disclosed embodiments. For example, in some embodiments, the image analysis system 320 may additionally manage dialogue and/or other interactions with the customer via a program 350.

The processor 310 may execute one or more programs 350 located remotely from the image analysis system 320. For example, the image analysis system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include an image analysis system database 360 for storing related data to enable the image analysis system 320 to perform one or more of the processes and functionalities associated with the disclosed embodiments.

The image analysis system database 360 may include stored data relating to status data (e.g., average session duration data, location data, idle time between sessions, and/or average idle time between sessions) and historical status data. According to some embodiments, the functions provided by the image analysis system database 360 may also be provided by a database that is external to the image analysis system 320, such as the database 416 as shown in FIG. 4.

The image analysis system 320 may also be communicatively connected to one or more memory devices (e.g., databases) locally or through a network. The remote memory devices may be configured to store information and may be accessed and/or managed by the image analysis system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The image analysis system 320 may also include one or more I/O devices 370 that may comprise one or more interfaces for receiving signals or input from devices and providing signals or output to one or more devices that allow data to be received and/or transmitted by the image analysis system 320. For example, the image analysis system 320 may include interface components, which may provide interfaces to one or more input devices, such as one or more keyboards, mouse devices, touch screens, track pads, trackballs, scroll wheels, digital cameras, microphones, sensors, and the like, that enable the image analysis system 320 to receive data from a user (such as, for example, via the user device 402).

In examples of the disclosed technology, the image analysis system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The image analysis system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The image analysis system 320 may be configured to adjust model parameters during training. Model parameters may include weights, coefficients, offsets, or the like. Training may be supervised or unsupervised.

The image analysis system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The image analysis system 320 may be configured to optimize statistical models using known optimization techniques.

Furthermore, the image analysis system 320 may include programs configured to retrieve, store, and/or analyze properties of data models and datasets. For example, image analysis system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The image analysis system 320 may include algorithms to determine a data type, key-value pairs, row-column data structure, statistical distributions of information such as keys or values, or other property of a data schema may be configured to return a statistical profile of a dataset (e.g., using a data-profiling model). The image analysis system 320 may be configured to implement univariate and multivariate statistical methods. The image analysis system 320 may include a regression model, a Bayesian model, a statistical model, a linear discriminant analysis model, or other classification model configured to determine one or more descriptive metrics of a dataset. For example, image analysis system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The image analysis system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, image analysis system 320 may be configured to generate a similarity metric representing a measure of similarity between data in a dataset. A similarity metric may be based on a correlation, covariance matrix, a variance, a frequency of overlapping values, or other measure of statistical similarity.

The image analysis system 320 may be configured to generate a similarity metric based on data model output, including data model output representing a property of the data model. For example, image analysis system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The image analysis system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The image analysis system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, image analysis system 320 is configured to generate and/or train a classification model to classify a dataset, consistent with disclosed embodiments.

The image analysis system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connection. Prediction models may additionally or alternatively include classification and regression trees, or other types of models known to those skilled in the art. To generate prediction models, the image analysis system may analyze information applying machine-learning methods.

While the image analysis system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the image analysis system 320 may include a greater or lesser number of components than those illustrated.

FIG. 4 is a block diagram of an example system that may be used to view and interact with alert system 408, according to an example implementation of the disclosed technology. The components and arrangements shown in FIG. 4 are not intended to limit the disclosed embodiments as the components used to implement the disclosed processes and features may vary. As shown, alert system 408 may interact with a user device 402 via a network 406. In certain example implementations, the alert system 408 may include a local network 412, an image analysis system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the alert system 408. In some embodiments, the user device 402 may include or incorporate electronic communication devices for hearing or vision impaired users.

Alert system 408 may include cameras 404a and 404b or imaging devices. The cameras may be used to receive optical or near infrared image or video data. Cameras 404a and 404b may be connected to the local network. 412, a larger network 406, or may be at a remote location. Cameras may be closed-circuit television (CCTV) cameras surrounding a location. Cameras may be located on user devices, such as user device 402.

Users may include individuals such as, for example, subscribers, clients, or military personnel. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The alert system 408 may be associated with and optionally controlled by one or more entities such as the military, a business, corporation, individual, partnership, or any another entity. In some embodiments, the alert system 408 may be controlled by a third party on behalf of another business, corporation, individual, partnership. The alert system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a website that a user device may access by providing an attempted login that are authenticated by the image analysis system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the alert system 408 to interact with one another and to connect to the network 406 for interacting with components in the system 400 environment. In some embodiments, the local network 412 may include an interface for communicating with or linking to the network 406. In other embodiments, certain components of the alert system 408 may communicate via the network 406, without a separate local network 406.

The alert system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access alert system 408 using the cloud computing environment. User device 402 may be able to access alert system 408 using specialized software. The cloud computing environment may eliminate the need to install specialized software on user device 402.

In accordance with certain example implementations of the disclosed technology, the alert system 408 may include one or more computer systems configured to compile data from a plurality of sources the image analysis system 320, web server 410, and/or the database 416. The image analysis system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

Although the preceding description describes various functions of a web server 410, a image analysis system 320, and a database 416 in some embodiments, some or all of these functions may be carried out by a single computing device.

FIG. 5 shows an illustration of a graphical user interface 500 used with image analysis system 320 and alert system 408. Alert system 408 may provide the graphical user interface 500 to a user device 402. The alert system 408 and/or image analysis system 320 may generate graphical user interface 500 and transmit graphical user interface 500 to the user device 402. Alternatively, alert system 408, image analysis system 320, and user device 402 may alternatively be all performed by the same device. In an embodiment where the user device 402 is separate from the alert system 408 and image analysis system 320, the user device 402 may be able to receive user inputs from a user (e.g., through a mouse, keyboard, touchscreen, or other input means). The user device 402 may then transmit the user inputs to the alert system 408 and/or the image analysis system 320. This may allow the user to interact with the data from the alert system 408 and/or image analysis system 320, such as by changing the graphical user interface 500. The user may be able to interact with data provided by image analysis system 320 to change the output on the graphical user interface 500 in real-time.

The graphical user interface may provide the collective output of image analysis system 320 over a number of frames for a number of different objects and cameras. The graphical user interface 500 may contain a main camera view 510 with dialog buttons 512 (e.g., play, pause, fast forward) to allow the user to control the video feed. The graphical user interface 500 may also show a timeline 514 detailing the current frame or time of the frame. The main camera view 510 may show an object (circle in the middle of box) identified in a bounding box 516, with path or estimated path, or future path 517, and anticipated target of the object 518. The user may be able to turn off the bounding box 516, estimated path 517, and anticipated target (or target zone) 518. Each of the bounding box 516, estimated path 517, or anticipated target 518 may change with each frame of the video presented to user on graphical user interface 500. Objects may be highlighted in other ways besides bounding boxes 516.

The graphical user interface 500 may also comprise a list of camera sources 520, with a number of different cameras available for the user to view. The user may be able to use a selection device to choose a camera view. The chosen camera view may then be presented as the main camera view 510. The graphical user interface 500 may present an incident pane 530 with assorted detection incidents as detected by image analysis system 320. The graphical user interface 500 may present a map 540 showing the position of different cameras around a location (such as a military base). The positions of the cameras may selectable, so that the user may select a camera on the map to be presented on the main camera view 510. The graphical user interface 500 may also present metadata 550 regarding the main camera view 510 about recent frames showing the locations of the bounding boxes on each frame. Furthermore, the graphical user interface 500 may present a system health area showing system problems, such the status of certain camera feeds or storage space. Overall, the graphical user interface 500 may visually represent the output of image analysis system 320 and alert system 408 integrated from a number of different camera video feeds over different time frames.

The graphical user interface 500 may be able to specifically highlight certain bounding boxes 516 of interest. Alternatively, the graphical user interface 500 may be able to provide audio/visual warning of incoming target or target of interest. In other embodiments, the alert system 408 may provide specific warnings to other user devices 402 if the alert system 408 recognizes that the user device 402 is in the target zone 518 of a UAS. This may be completed by comparing the location of a user device 402 to the indicated target zone 518 of the UAS by locating the user device 402 using GPS or cellular triangulation. In a base defense system, the alert system 408 may be able to send alerts to a plethora of user devices within a determined target zone 518. The present system may be able to interact with base defense systems in order to coordinate base defenses against a detected object.

### EXAMPLE USE CASES

The following example use cases describes typical usage scenarios. This section is intended solely for explanatory purposes and not in limitation.

### Explosion and Fire Detection

The detonation of explosives create a tell-tale flash with sharply-defined temporal and photometric signatures. The processes defined in this specification may be highly effective at detecting explosions such as warhead detonation, small arms muzzle flash, and artillery firing. The sudden, brief illumination arising from explosions may enable detection filters to identify these events as being distinct from other types of events and ONIR-emitting objects. The system may also detect the longer-duration light emission from petrochemical refinery flares, building fires, and campfires.

Explosions and fires present unique opportunities for the calculation of important properties. The sharp time signature of explosions enable the time-alignment of all cameras that detect the event. By assessing the network time protocol-derived time reported by each camera, the system may be able to determine a rough alignment. Additional active techniques may be undertaken to measure the jitter or misalignment in time recorded by each camera. The use of network administration tools such as ping, dig, traceroute, and others known to those skilled in network administration allow for network latency probes to be used to better calculate the inaccuracies in the time recorded by each network device (e.g., an IP network camera). Comprehensive assessments of the jitter and latency can be used to develop a time-correction map, which can in turn be used to better map key parameters of an explosion. As a non-limiting example, the detection of a large bomb's flash by a large ensemble of networked CCTV security cameras, combined with accurate time offsets between those cameras, can provide confirmation that a particular explosion is non-nuclear in origin since such weapons produce a double-flash. Although an individual camera would be unable to detect both flashes, the time-correction across cameras may enable such a determination. Events, such as the Beirut port explosion, are of such a large magnitude that the local population seeks immediate clarity as to the nature of the blast. The real-time application of exemplary disclosed systems and methods provide that panic-preventing capability.

### EOD Solution

In another application, the subject technology may be used to detect unexploded ordnance, commonly referred to as UXO. Using unmodified security cameras to detect, track, and classify artillery, rockets, and potentially cluster munitions as they fly, fall, and impact allows the system to warn personnel prior to their impact that they are in danger. Once those weapons fall, some are likely to fail to detonate, which creates a danger for both warfighters and civilians at a later date, especially when the conflict occurs in or near a city. If the system tracks falling munitions and then does not detect the tell-tale flash of an explosion, there is a significant chance there is a UXO threat. Taken together, the image analysis system 320 may allow unmodified cameras to detect munitions, determine the approximate point of impact, assess if they fail to explode and are therefore UXO, enable specially trained bomb disposal personnel to travel to the UXO. As an optional system augmentation, the bomb disposal technicians or robots can use other video analysis technologies that enable unmodified cameras to detect radioactive materials, for example a radiological dispersal device (RDD or “Dirty Bomb”) as described in U.S. Pat. No. 7,391,028 issued Jun. 24, 2008, U.S. Pat. No. 7,737,410 issued Jun. 15, 2010, U.S. Pat. No. 8,158,950 issued Apr. 17, 2012, U.S. Pat. No. 8,324,589 issued Dec. 4, 2023, U.S. Pat. No. 8,563,937 issued Oct. 22, 2013, and U.S. Pat. No. 9,000,386 issued Apr. 7, 2015 which are hereby incorporated by reference in their entirety.

### Detecting Objects on Ground or in Space

The system may be able to detect objects in recorded video. Logs and tracks of objects may be saved and downloaded from the system. The system may operate at a natural resolution of 640×480 or other common resolutions, such as 1920×1080 or 4 k, 5 k, or 8 k. The system may use downsampling for some sources. Downsampling from certain high-resolution sources may not be advisable. Using the system with HD cameras may require implementation of an automated slicer/zipper set of utilities. The system may detect both optical and NIR emitters against low-light backgrounds. The system may work with thermal IR and other “image” based data (such as including Synthetic Aperture Radar (SAR)). The machine learning model may require individual training.

The system may include dynamic graphical user interfaces by highlighting the detected object. The highlight may move with the detected object. The graphical user interface may show a trajectory of the detected object. The trajectory of the detected object may change as more data is gathered about the detected object. The graphical user interface may show a projected point of impact of the detected object based on a trajectory or a calculated point of origin based on the observed trajectory.

### Detect, Track, and Classify a UAS

The system observes a set of four lights in the sky. As the lights move, they stay close to each other and move at identical, or nearly identical angular speeds. They move relative to each other, but the system deduces that the motion of the lights are consistent with a single solid body undergoing solid body rotation relative to the camera. From viewing the four lights at various orientations as they move, the system is able to estimate the relative spacings between the lights. From their relative and absolute motion and color and brightness of the lights, the system predicts which lights define the front of the object and which are associated with the back. As an example, referencing its database of known drones, their sizes, properties of the drone's lights (color, brightness, total brightness changes, total color changes, rate of change of brightness, and rate of change of color), and the physical arrangement of lights, the system gives probabilities that this object is one of several known models of DJI drones. For each possibility, the system uses a database to find the physical dimensions of the drone, and thus can immediately estimate the distance of the intruder and its speed. As a test identification, the system posits that the detected object is a specific large drone model. However, for the estimated distance to be consistent with the observed angular size, the total air speed would have to be greater than the known fastest speed possible for that model, therefore that hypothesis is rejected. Following that rejection, other models are still possible. The system continues to observe and collect data, to refine the angular size and speed estimates, ultimately eliminating other potential models as the process continues.

In a second example, consider further that these tracked lights pass behind a building and are lost. Shortly afterwards four lights appear on the other side of the building. The system identifies a possible new object, and assess competing hypotheses, (1) that the new detection is, or (2) is not, the same object that it lost seconds earlier. The positional distribution, brightness, and color of the object's lights are measured to be consistent with the same model types identified in the database previously. This assessment makes it highly likely that the drone just observed emerging from behind the building is the same object that went behind it. Continuing to track the drone yields more information. The distance to the building is known, so the system places a lower limit on the distance to the drone since the drone should be further than the building to have been eclipsed by the structure. This assessment removes from consideration several small drone models which would not have their lights separated by the observed angle at that distance.

### Identify a Mapping LiDAR Sensor

A single light in the sky is detected by the system. The system determines the projected location on the sky and the object's bearing. A second camera also receives a single light and provides its estimate of location and bearing. The system compares the two pointing vectors for the cameras and concludes that there is a region where the fields of view overlap. As the light remains visible in both cameras, the system updates the likely position of the object, and also estimates its velocity. Given this information, the system predicts that it should also be in the field of view of a third camera, but it is not detected there. Based on the current best position of the location of the object, and prior observations along that line of sight that show there are no known obstructions, this camera would be viewing the object from the side. The system concludes that the object's emission is pointing forwards (in the direction of travel).

A short time later, the object disappears on the first camera, but something appears at the predicted position on the third camera. The system continues to track the object, and the subsequent motion is consistent with the object having turned and begun to move in a new direction. The system continues to track the object, predicting when it may appear in other cameras, and noting when and in which cameras it is detected. Information from all detections are combined to maintain a prediction for the future position and motion of the object. Deviations from these predictions are combined with a model of the physical capabilities of the object to predict where the object can potentially go and how fast. In addition to assessments of the objects speed and agility, it is possible to infer such capabilities as the potential payload mass and distribution. Other assessments of variation of speed, direction, and attitude stability allow for the characterization and eventual identification of the remote pilot. Over time the system builds a database of reaction time, ability to maintain velocity, jitter in flight control, and other physical manifestations of the skill and reaction time of each pilot, remote pilot, and automatic pilot software version.

If the light starts disappearing and reappearing in the various cameras, the system may assess whether the changes are periodic in nature. This kind of behavior is indicative of potential scanning or mapping of a facility with, for example, a LIDAR turret. The inferred characteristics of the light variations provide additional information about the detected object. Changes in the pattern as the object moves may indicate changes in the orientation and components of the object, and help constrain inferences on its identity or model type. This information can be derived in the case where the scanning LIDAR emission, for example, is blocked by part of the structure of the drone when seen from a particular camera or cameras as the object moves or rotates. This data can corroborate or refute an inferred object's model type.

### Detect, Track, Characterize, and Determine Changes in a Satellite

The system detects a slowly moving light in the sky, measures its movement, and determines it to be either a high-flying plane or a satellite. By comparing the object's observed location with a database of known satellite orbits, the object is identified to be a particular satellite. Photometric measurements are made to verify that the object's apparent size is consistent with a point source and its angular extent varies coherently with the angular extent of stars, thereby verifying its identity as a satellite. In addition, the photometry and access to a high-precision time signal allows the system to calculate accurate and precise orbital elements and lightcurve. The orbital elements are compared to known ephemerides to assess if the object is known, and whether its orbit has changed since its last known measurements. The measurements of brightness and color are used to build a lightcurve, which is assessed for constancy during this orbit and its historical brightness and variations. The degree of brightness and color constancy, potential periodicity in variations, and deviations from periodicity of brightness variations all inform the understanding of the satellite's movement in orbit. That is, constant brightness suggests a smooth surface and either little variation in Sun-satellite-camera angle (the object is rotating synchronously with the solar angle) or a high degree of axisymmetry. Alternatively, cyclic variations perhaps with a 1.5 second periodicity in brightness suggest the satellite has a spin with that frequency. Another possibility might be a chaotically changing lightcurve indicative of a satellite tumbling in orbit.

Brightness measurements may be made using the relative brightness of the object compared to that of known stars, or absolute brightness relative to specific standard stars measured during optimal, photometric observing conditions. While relative photometry can be readily used to infer orbital stability, absolute brightness measurements can be used to assess if the satellite has sustained damage or other circumstances that would change its reflectivity and/or surface area and/or its anticipated attitude with respect to the Sun-satellite-camera viewing angle.

If unexpected changes to orbital elements are calculated, the system can deduce the amount of change in the satellite's velocity, and therefore how much fuel may have been used to alter its orbit.

With a single camera, the system has less information on the radial distance. However, the system may know the direction and altitude of the detected object. This can be estimated from mapping the location, orientation, and image scale of the camera to define the field of view. For every position in the view, there may be a vector along which the detected object should lie. However, the optimal method is to have the same object detected in multiple cameras so that the position can be determined from the vector overlap.

If the object is detected in a single camera's view, there are options to gain more actionable knowledge. If the object can be identified, for example, by the pattern of its lights (e.g., by formulating length ratios as with facial recognition polygons), and its physical dimensions are known, then the system can estimate the distance from the camera by comparing the angular size to the know physical size. Even where this information is not known, the system can apply physical arguments to constrain the motion. This motion can be broken into two components. The angular motion is that through the field of view. The radial motion is towards or away from the camera. The latter is detectable by the system through changes in the apparent size of the object, if it is resolved. The angular motion is readily measured by the system from the changes in the position of the object in the field of view. The system can convert of these motions to a distance by considering physically reasonable velocities. Any detected motion could be a small, nearby object moving slowly, or a larger, more distant object moving quickly. Size and speed increases linearly with presumed distance. The observed behavior and physical reasonableness constrain the range of plausible distances. For example, a small UAS of known model is constrained to a maximum velocity (e.g., 60 km/hr). That maximum linear velocity translates to a maximum distance from the camera for a given angular velocity.

In some examples, disclosed systems or methods may involve one or more of the following clauses:
Clause 1: An object detection system, the system comprising: one or more processors; memory in communication with the one or more processors and storing instructions that are configured to cause the system to: receive video data from one or more cameras; process the video data using one or more machine learning models of a first group of machine learning models to detect one or more objects, wherein each machine learning model of the first group of machine learning models is trained to detect different morphological classes of objects; responsive to detecting a first object of the one or more objects by a first machine learning model of the first group of machine learning models, continuously monitor the first object using the first machine learning model; track characteristics of the one or more objects over time; calculate derived characteristics from the tracked characteristics; classify, using one or more machine learning models of a second group of machine learning models, each of the one or more objects based on the tracked characteristics and the derived characteristics; compare each of the classifications to a database of known objects; predict an estimated identity of each of the one or more objects based on the comparison; and predict a future path of motion for each of the one or more objects based on the estimated identity, the derived characteristics, and the tracked characteristics.
Clause 2: The object detection system of clause 1, wherein the memory stores further instructions which are configured to cause the system to: preprocess the video data, wherein preprocessing the video data comprises: determining a median value over a number of video frames for an optical characteristic; and subtracting the median value from pixel values in each frame.
Clause 3: The object detection system of clause 1, wherein: the cameras are configured to capture infrared emissions, near-infrared emissions, infrared reflections, near-infrared reflections, or combinations thereof; the cameras are digital closed-circuit television (CCTV) cameras, mobile device cameras, or combinations thereof; and the one or more objects are LiDAR emitters, optical emitters, near-infrared emitters, optical reflectors, near-infrared reflectors, or combinations thereof.
Clause 4: The object detection system of clause 1, wherein: the future path of motion is predicted for each of the one or more objects using one or more machine learning models of a third group of machine learning models; and the one or more objects is an unmanned aerial vehicle, aircraft, rocket, tracer bullet, satellite, or combinations thereof.
Clause 5: The object detection system of clause 1, wherein the tracked characteristics of the one or more objects comprise position, distance, velocity, brightness, color, shape, or combinations thereof.
Clause 6: The object detection system of clause 1, wherein: the one or more cameras comprise two or more cameras; and the derived characteristics of the one or more objects comprise physical size, distances from each of the two or more cameras, velocity, acceleration, rotation, or combinations thereof.
Clause 7: The object detection system of clause 1, wherein the memory stores further instructions which are configured to cause the system to: generate a graphical user interface showing the tracked characteristics, the derived characteristics, and the future path of motion each of the one or more objects; and transmit the graphical user interface to a user device for display.
Clause 8: An object detection system, the system comprising: one or more processors; memory in communication with the one or more processors and storing instructions that are configured to cause the system to: receive video data from one or more cameras; process one or more first frames of the video data using one or more machine learning models of a first group of machine learning models to detect one or more objects, wherein each machine learning model of the first group of machine learning models is trained to detect different types of objects; responsive to detecting a first object of the one or more objects using a first machine learning model of the first group of machine learning models, process one or more second frames of the video data using the first machine learning model to track characteristics of the first object over time; and calculate derived characteristics from the tracked characteristics.
Clause 9: The object detection system of clause 8, wherein the memory stores further instructions which are configured to cause the system to: generate a graphical user interface showing the tracked characteristics and the derived characteristics for the first object; and transmit the graphical user interface to a user device for display.
Clause 10: The object detection system of clause 9, wherein the memory stores further instructions which are configured to cause the system to: classify, using one or more machine learning models of a second group of machine learning models, the first object of one or more objects based on the tracked characteristics and derived characteristics; compare of the classifications of the first object to a database of known objects; predict an estimated identity of the first object of the one or more objects based on the comparison; and predict a future path of motion for the first object of the one or more objects using one or more machine learning models of a third group of machine learning models based on the estimated identity and the tracked characteristics.
Clause 11: The object detection system of clause 10, wherein the memory stores further instructions which are configured to cause the system to: generate an updated graphical user interface showing the future path of motion and the estimated identity for the first object; and transmit the updated graphical user interface to the user device for display.
Clause 12: The object detection system of clause 8, wherein the memory stores further instructions which are configured to cause the system to: periodically process the one or more second frames of the video data using a second machine learning model different from the first machine learning model of the first group of one or more machine learning models.
Clause 13: The object detection system of clause 12, wherein the memory stores further instructions which are configured to cause the system to: detect a second object of the one or more objects using the second machine learning model of the first group of one or more machine learning models; and responsive to detecting the second object of the one or more objects using the second machine learning model of the first group of one or more machine learning models, process one or more third frames of the video data using the second machine learning model to track characteristics of the second object over time.
Clause 14: The object detection system of clause 13, wherein the first machine learning model tracks the first object and the second machine learning model tracks the second object simultaneously.
Clause 15: The object detection system of clause 8, wherein the memory stores further instructions which are configured to cause the system to: process one or more fourth frames of the video data to detect a third object of the one or more objects using the first machine learning model of the first group of one or more machine learning models, the third object different from the first object; and responsive to detecting the third object of the one or more objects using the first machine learning model of the first group of one or more machine learning models, process one or more fifth frames of the video data using the first machine learning model to track characteristics of the third object over time.
Clause 16: The object detection system of clause 15, wherein the first learning machine model tracks the first object and the third object simultaneously.
Clause 17: An object detection system, the system comprising: one or more processors; memory in communication with the one or more processors and storing instructions that are configured to cause the system to: receive video data from one or more sensors; process the video data to detect one or more objects using a first group of one or more machine learning models; track characteristics of the one or more objects over time; classify, using a second group of one or more machine learning models, each of the one or more objects based on the tracked characteristics; compare each of the classifications to a database of known objects; predict an estimated identity of each of the one or more objects based on the comparison; and predict a future path of motion for each of the one or more objects based on the estimated identity and the tracked characteristics.
Clause 18: The object detection system of clause 17, wherein the memory stores further instructions which are configured to cause the system to: generate and update a graphical user interface in real-time showing the tracked characteristics for each of the one or more objects; and transmit the graphical user interface to a user device for display.
Clause 19: The object detection system of clause 17, wherein the sensors further comprise filters for use in daylight conditions.
Clause 20: The object detection system of clause 17, wherein night conditions are associated with a first subset of the first group of the one or more machine learning models and daylight conditions are associated a second subset of the first group of the one or more machine learning models.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An object detection system, the system comprising:
one or more processors;
memory in communication with the one or more processors and storing instructions that are configured to cause the system to:
receive video data from one or more cameras;
process the video data using one or more machine learning models of a first group of machine learning models to detect one or more objects, wherein each machine learning model of the first group of machine learning models is trained to detect different morphological classes of objects;
responsive to detecting a first object of the one or more objects by a first machine learning model of the first group of machine learning models, continuously monitor the first object using the first machine learning model;
track characteristics of the one or more objects over time;
calculate derived characteristics from the tracked characteristics;
classify, using one or more machine learning models of a second group of machine learning models, each of the one or more objects based on the tracked characteristics and the derived characteristics;
compare each of the classifications to a database of known objects;
predict an estimated identity of each of the one or more objects based on the comparison; and
predict a future path of motion for each of the one or more objects based on the estimated identity, the derived characteristics, and the tracked characteristics.

2. The object detection system of claim 1, wherein the memory stores further instructions which are configured to cause the system to:
preprocess the video data, wherein preprocessing the video data comprises:
determining a median value over a number of video frames for an optical characteristic; and
subtracting the median value from pixel values in each frame.

3. The object detection system of claim 1, wherein:
the cameras are configured to capture infrared emissions, near-infrared emissions, infrared reflections, near-infrared reflections, or combinations thereof;
the cameras are digital closed-circuit television (CCTV) cameras, mobile device cameras, or combinations thereof; and
the one or more objects are LiDAR emitters, optical emitters, near-infrared emitters, optical reflectors, near-infrared reflectors, or combinations thereof.

4. The object detection system of claim 1, wherein:
the future path of motion is predicted for each of the one or more objects using one or more machine learning models of a third group of machine learning models; and
the one or more objects is an unmanned aerial vehicle, aircraft, rocket, tracer bullet, satellite, or combinations thereof.

5. The object detection system of claim 1, wherein the tracked characteristics of the one or more objects comprise position, distance, velocity, brightness, color, shape, or combinations thereof.

6. The object detection system of claim 1, wherein:
the one or more cameras comprise two or more cameras; and
the derived characteristics of the one or more objects comprise physical size, distances from each of the two or more cameras, velocity, acceleration, rotation, or combinations thereof.

7. The object detection system of claim 1, wherein the memory stores further instructions which are configured to cause the system to:
generate a graphical user interface showing the tracked characteristics, the derived characteristics, and the future path of motion each of the one or more objects; and
transmit the graphical user interface to a user device for display.

8. An object detection system, the system comprising:
one or more processors;
memory in communication with the one or more processors and storing instructions that are configured to cause the system to:
receive video data from one or more cameras;
process one or more first frames of the video data using one or more machine learning models of a first group of machine learning models to detect one or more objects, wherein each machine learning model of the first group of machine learning models is trained to detect different types of objects;
responsive to detecting a first object of the one or more objects using a first machine learning model of the first group of machine learning models, process one or more second frames of the video data using the first machine learning model to track characteristics of the first object over time; and
calculate derived characteristics from the tracked characteristics.

9. The object detection system of claim 8, wherein the memory stores further instructions which are configured to cause the system to:
generate a graphical user interface showing the tracked characteristics and the derived characteristics for the first object; and
transmit the graphical user interface to a user device for display.

10. The object detection system of claim 9, wherein the memory stores further instructions which are configured to cause the system to:
classify, using one or more machine learning models of a second group of machine learning models, the first object of one or more objects based on the tracked characteristics and derived characteristics;
compare of the classifications of the first object to a database of known objects;
predict an estimated identity of the first object of the one or more objects based on the comparison; and
predict a future path of motion for the first object of the one or more objects using one or more machine learning models of a third group of machine learning models based on the estimated identity and the tracked characteristics.

11. The object detection system of claim 10, wherein the memory stores further instructions which are configured to cause the system to:
generate an updated graphical user interface showing the future path of motion and the estimated identity for the first object; and
transmit the updated graphical user interface to the user device for display.

12. The object detection system of claim 8, wherein the memory stores further instructions which are configured to cause the system to:
periodically process the one or more second frames of the video data using a second machine learning model different from the first machine learning model of the first group of one or more machine learning models.

13. The object detection system of claim 12, wherein the memory stores further instructions which are configured to cause the system to:
detect a second object of the one or more objects using the second machine learning model of the first group of one or more machine learning models; and
responsive to detecting the second object of the one or more objects using the second machine learning model of the first group of one or more machine learning models, process one or more third frames of the video data using the second machine learning model to track characteristics of the second object over time.

14. The object detection system of claim 13, wherein the first machine learning model tracks the first object and the second machine learning model tracks the second object simultaneously.

15. The object detection system of claim 8, wherein the memory stores further instructions which are configured to cause the system to:
process one or more fourth frames of the video data to detect a third object of the one or more objects using the first machine learning model of the first group of one or more machine learning models, the third object different from the first object; and
responsive to detecting the third object of the one or more objects using the first machine learning model of the first group of one or more machine learning models, process one or more fifth frames of the video data using the first machine learning model to track characteristics of the third object over time.

16. The object detection system of claim 15, wherein the first learning machine model tracks the first object and the third object simultaneously.

17. An object detection system, the system comprising:
one or more processors;
memory in communication with the one or more processors and storing instructions that are configured to cause the system to:
receive video data from one or more sensors;
process the video data to detect one or more objects using a first group of one or more machine learning models;
track characteristics of the one or more objects over time;
classify, using a second group of one or more machine learning models, each of the one or more objects based on the tracked characteristics;
compare each of the classifications to a database of known objects;
predict an estimated identity of each of the one or more objects based on the comparison; and
predict a future path of motion for each of the one or more objects based on the estimated identity and the tracked characteristics.

18. The object detection system of claim 17, wherein the memory stores further instructions which are configured to cause the system to:
generate and update a graphical user interface in real-time showing the tracked characteristics for each of the one or more objects; and
transmit the graphical user interface to a user device for display.

19. The object detection system of claim 17, wherein the sensors further comprise filters for use in daylight conditions.

20. The object detection system of claim 17, wherein night conditions are associated with a first subset of the first group of the one or more machine learning models and daylight conditions are associated a second subset of the first group of the one or more machine learning models.
